(19) United States
(12) Patent Application Publication
(10) Pub. No.: US 2017/0124905 A1
(43) Pub. Date: May 4, 2017

(54) SYSTEM AND METHOD FOR ENABLING A USER TO OVERCOME SOCIAL ANXIETY

(71) Applicants: Jonnalagadda Sasidhar, Sleepy Hollow, NY (US); Manisha Naresh Nagpal, Bangalore (IN); Gowthami Vasudev, Bangalore (IN)

(72) Inventors: Jonnalagadda Sasidhar, Sleepy Hollow, NY (US); Manisha Naresh Nagpal, Bangalore (IN); Gowthami Vasudev, Bangalore (IN)

(73) Assignee: DHARMA LIFE SCIENCES LLC, Sleepy Hollow, NY (US)

(21) Appl. No.: 14/975,888

(22) Filed: Dec. 21, 2015

Related U.S. Application Data
(63) Continuation-in-part of application No. 14/931,868, filed on Nov. 4, 2015.

(51) Int. Cl. G09B 19/00; A63F 13/79; G09B 5/02

(52) U.S. Cl. CPC G09B 19/00; G09B 5/02; A63F 13/79

(57) ABSTRACT

A system is provided for enabling a user to overcome social anxiety. The system is configured to enable the user to engage in a first and a second activity in a virtual environment, directed to rewire a first and a second defective wiring, respectively. The first defective wiring results in an individual give priority to threatening information in social environments. The second defective wiring results in fear of negative evaluation by others. Symptom of the first and the second defective wirings is social anxiety. Engagement in the second activity is enabled after the user has at least participated in the first activity. Automated instructions are provided to the user to engage in activities performed in a real world environment directed to rewire the first and the second defective wiring.

### CROSS REFERENCE TO RELATED APPLICATION

This application is a continuation-in-part application of U.S. patent application Ser. No. 14/931,868 filed Nov. 4, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

The subject matter in general relates to behavioral traits in humans, and more particularly but not exclusively, the subject matter is directed to a technical solution to overcome social anxiety, which is a weak behavioral trait.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development. As an example, social anxiety may be caused by genetic predisposition and behaviorally inhibited temperament since a young age and experiencing or witnessing social defeat/humiliation, mainly during childhood.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him. Behavior of a person with social anxiety may include fear to respond in social situations with physical symptoms of increased heart rate, sweating, headaches and/or difficulty in breathing, tendency to avoid social situations, repetitive thoughts of anticipatory criticism from others, excessive focus on self and becoming conscious of the way they come across to others and not liking being the center of attention in any situation, among others.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a wholesome manner.

In light of the foregoing discussion there is a need for an improved technique to overcome social anxiety, which can be classified as a weak personality trait based on the goals of the person.

### SUMMARY

An embodiment provides a system for enabling a user to overcome social anxiety. The system includes an activity module. The activity module is configured to enable the user to engage in at least a first activity in a virtual environment. The first activity is directed to rewire a first defective wiring of the brain. The first defective wiring results in an individual giving priority to threatening information in social environments. The activity module is further configured to enable the user to engage in at least a second activity in the virtual environment. The second activity is directed to rewire a second defective wiring of the brain. The second defective wiring results in fear of negative evaluation by others. Symptom of the first and the second defective brain wirings is social anxiety. Additionally, the activity module is configured to provide automated instructions to the user to engage in at least one activity, wherein the one activity is performed in a real world environment. The activity is directed to rewire the first defective wiring of the brain. Furthermore, the activity module is configured to provide automated instructions to the user to engage in yet another activity. The yet another activity is performed in the real world environment. The yet another activity is directed to rewire the second defective wiring of the brain.

Another embodiment provides a method for enabling a user to overcome social anxiety. The method includes enabling the user to engage in at least a first activity in a virtual environment. The first activity is directed to rewire a first defective wiring of the brain. The first defective wiring results in an individual giving priority to threatening information in social environments. The user is enabled to engage in at least a second activity in the virtual environment. The second activity is directed to rewire a second defective wiring of the brain. The second defective wiring results in fear of negative evaluation by others. Symptom of the first and the second defective wirings is social anxiety. Further, automated instructions are provided to the user to engage in at least one activity. The one activity is performed in a real world environment. The activity is directed to rewire the first defective wiring of the brain. Furthermore, automated instructions are provided to the user to engage in yet another activity. The yet another activity is performed in the real world environment. The yet another activity is directed to rewire the second defective wiring of the brain.

Yet another embodiment provides a system for enabling a user to overcome social anxiety. The system includes an activity module configured to enable the user to engage in at least a first activity in a virtual environment, wherein the first activity is directed to rewire a first defective wiring of the brain, wherein the first defective wiring results in an individual giving priority to threatening information in social environments. The activity module is further configured to enable the user to engage in at least a second activity in the virtual environment, wherein the second activity is directed to rewire a second defective wiring of the brain, wherein the second defective wiring results in fear of negative evaluation by others, wherein symptom of the first and the second defective wirings is social anxiety, wherein engagement in the second activity is enabled after the user has at least participated in the first activity.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to overcome social anxiety;

FIG. 2 is a block diagram of an exemplary activity module 200 to overcome social anxiety;

FIG. 2A is a block diagram of an exemplary behavioral traits database 202 of the activity module 200 to overcome social anxiety;

FIG. 2B is a block diagram of an exemplary collection of games 204 present in the activity module 200 to overcome social anxiety;

FIG. 2C is a block diagram of an exemplary actions database 206 of the activity module 200 to overcome social anxiety; and

FIG. 3 illustrates a flowchart of an exemplary method for overcoming social anxiety.

### DETAILED DESCRIPTION

### I. OVERVIEW

### II. PRINCIPLE

### III. SYSTEM ARCHITECTURE

### IV. MODULES OF SYSTEM TO OVERCOME SOCIAL ANXIETY

### V. METHOD FOR OVERCOMING SOCIAL ANXIETY

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. OVERVIEW

Embodiments provide a technical solution to overcome social anxiety, which is a weak behavioral trait. The solution is based on a principle that genetic and environmental factors (may be referred to as “cause”) cause defects in human brain wiring (may be referred to as “defect”), and such defects in human brain wiring express themselves in the form of social anxiety (may be referred to as “symptoms”); hence, to overcome social anxiety, the defective brain wirings have to be rewired, thereby providing a wholesome and long term solution to weak behavioral traits.

In an embodiment, a system is provided to overcome social anxiety. The system may include an activity module. The activity module may be configured to enable the user to engage in activities in a virtual environment. The activities in the virtual environment facilitate rewiring of defective brain wirings, wherein the symptom of the defective brain wirings is social anxiety. The activity module may be further configured to provide automated instructions to gradually expose the user to situations in a real environment. The situations may be generally uncomfortable to the user as a result of the defective brain wirings. Exposure to such situation facilitates rewiring of the defective brain wirings.

The activity in the virtual environment may be a brain game. There may be a plurality of levels in the brain game. Each level in the game may have to be successfully completed by the user to unlock a subsequent higher level in the game.

The real world activity may take place in the real world environment, subsequent to the brain games. There may be a plurality of levels in the real world activity.

### II. PRINCIPLE

Social anxiety is a specific form of anxiety. It is an emotion characterized by discomfort or fear when a person is in a social interaction. It involves a concern of being judged or evaluated negatively by others.

Social anxiety is in fact a symptom or consequence of the way an individual's brain is wired. The way an individual's brain is wired is based on the joint influence of genetic and environmental factors. With regards to each kind of brain wiring, genetic and environmental factors may work together in different proportions.

With regards to social anxiety, the brain of the person with social anxiety is wired such that the person tends to give priority to threatening information in social environments, which may be considered as a defective brain wiring. Additionally, the brain of the person with social anxiety is wired such that the individual fears being negatively evaluated by others, which may be considered as another defective brain wiring. Such defective brain wiring may have been caused by one or more of genetic predisposition and behaviorally inhibited temperament since a young age and experiencing or witnessing social defeat/humiliation, mainly during childhood.

Embodiments provide a solution to rewire the defective brain wirings (addressing the defect) rather than just addressing the behavioral trait (symptom) without addressing the core defect. The solution is directed towards rewiring the defective brain wirings such that the ability to focus or prioritize on non threatening information in social environments is increased and ability to balance between positive and negative evaluation by other people and make a decision if the experience is good or not, is increased.

It is important to identify the brain wiring that results in development of a trait. A wholesome approach to overcome or eradicate a negative or a weak behavioral trait in a person would be to implement ways to rectify defect in the brain wiring.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

Individuals with social anxiety tend to focus on threatening information rather than non threatening information in social environments and they fear about being negatively evaluated by others. Different brain regions and neural network of the individual are responsible for such defects. Ventromedial Prefrontal Cortex (VmPFC), Orbito Frontal Cortex (OFC), Dorsal Anterior Cingulate cortex (dACC) and Inferior frontal Gyrus (IFG) are important brain regions or the blocks. In socially anxious individuals, high neural activity is seen in the amygdala region by input related to previous conditioning and reinforcement experiences which are mainly related to social events. The previous experiences are conveyed by projections from the thalamus, hippocampus and the frontal cortical structures. In socially anxious individuals, low neural activity is seen in the Dorsal Anterior Cingulate cortex (dACC) region. This area is involved in cognitive reappraisal. It has been proven that it detects and evaluates personal errors and decides how bad they are. It is the major part of the brain which controls confidence also. The Ventromedial Prefrontal Cortex (VmPFC) plays an important role in regulating and inhibiting responses to emotions in various situations. The VmPFC receives information from the environment and input from dACC. The output of VmPFC controls different physiological responses and behaviors. It's also involved in personal and social decision making. These areas share extensive, reciprocal projections with the amygdala, through which the amygdala can modulate VmPFC neuronal activity and the VmPFC can modulate amygdala-mediated responses to emotionally salient stimuli. In patients with social anxiety, this area is less active compared to healthy controls. The Orbito Frontal Cortex (OFC) is important in signaling the expected rewards/punishments of an action, given the particular details of a situation. In doing this, the brain is capable of comparing the expected reward/punishment with the actual delivery of reward/punishment, thus, making the OFC critical for adaptive learning. Individuals with social anxiety have lower activity in this region. The inferior frontal gyrus (IFG) plays an important role in triggering emotional suppression. Emotional suppression is a behavioral strategy that involves inhibiting ongoing emotion. Individuals with social anxiety have greater activity in this region.

When a normal individual faces a humiliating situation, the dACC would get activated in order to enable the person to cope up with it and reappraise the situation. However, individual (with a predisposition of a behaviorally inhibited temperament, as in the case of social anxiety) real world to repeated humiliating situations (e.g. from parents, friends or any social situation), especially in childhood, damages the ability of the dACC to reappraise the situation and fails to protect an individual from feeling fearful in such situations. The process of making a decision as to which emotion needs to be attributed to the situation is done by the VmPFC. In this case, it attributes a negative fearful emotion to social situations. The orbito frontal cortex then perceives the situation to be threatening and non-rewarding. All this information results in the person developing a fear of negative evaluation and criticism. The inferior frontal gyrus then suppresses these emotions for emotional regulation, instead of picking more successful strategies such as reappraisal. These signals are then received by the amygdala and the person exhibits an anxious response. This is stored as a negative memory in the hippocampus. The anxiety response from the amygdala then activates the behavioral inhibition system in the striatum which results in the person avoiding social situations in the future.

Since the frontal lobe is not functioning optimally in social situations, the connection between the thalamus and amygala is strengthened over a period of time and the person immediately feels anxious when exposed to such social situations. The amygdala also sends immediate signals to the striatum to avoid such situations. The amygdala also has reciprocal connections with the thalamus which then triggers the person to look for threatening cues in the environment (mainly in the social environment).

### III. SYSTEM ARCHITECTURE

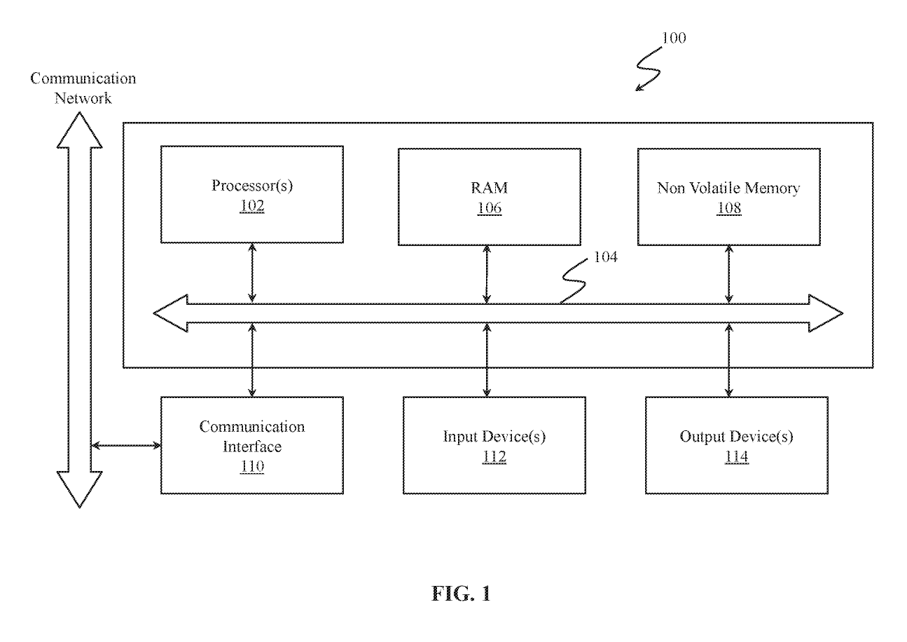

Referring to the figures, more particularly to FIG. 1, an exemplary architecture of an exemplary system 100 to overcome social anxiety is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. MODULES OF SYSTEM TO OVERCOME SOCIAL ANXIETY

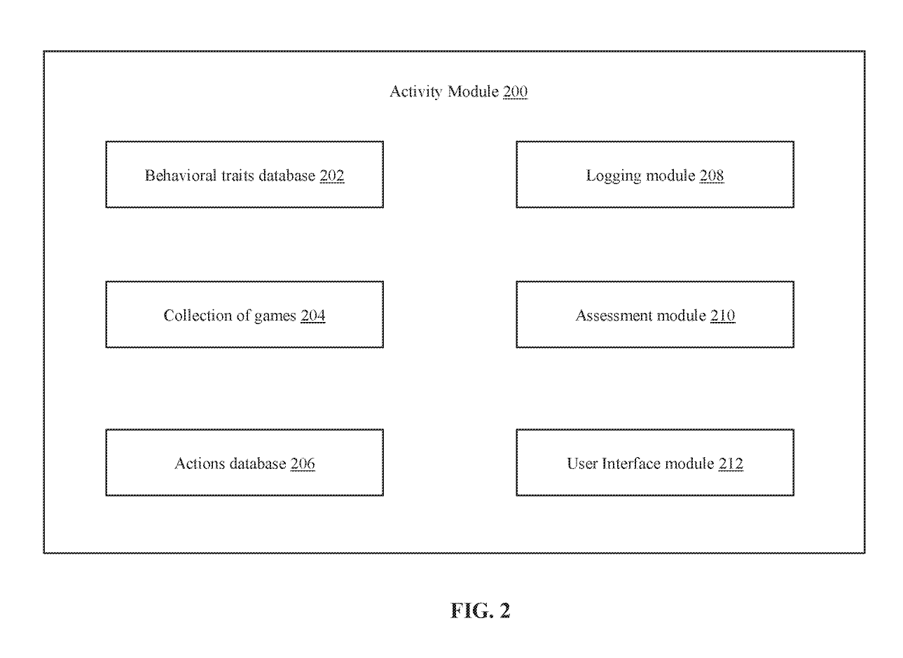

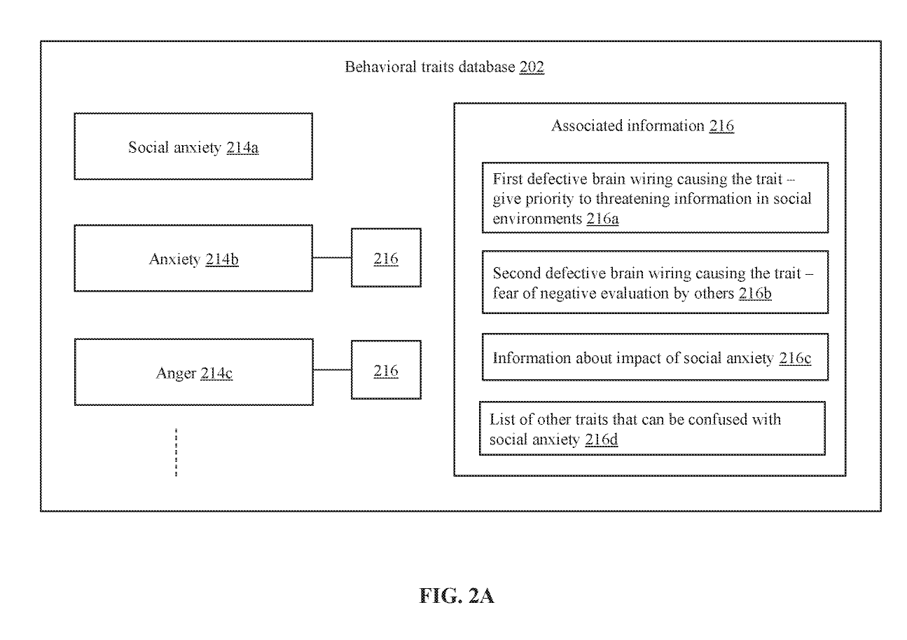

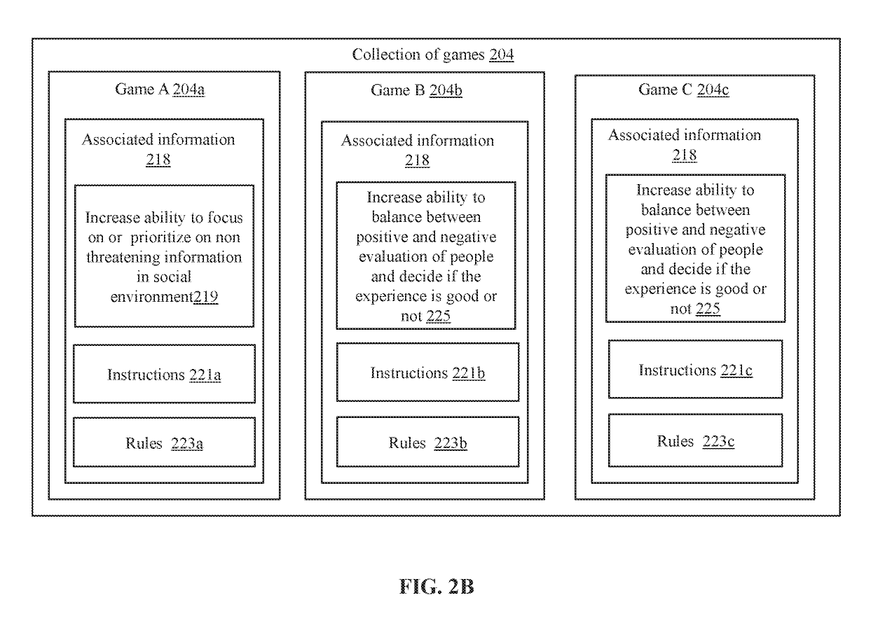

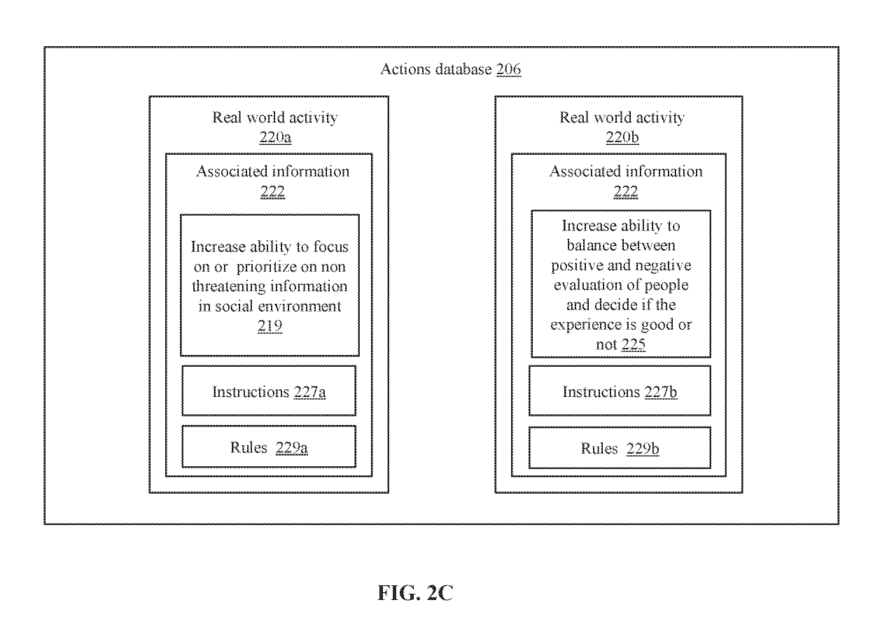

Referring to the figures, and more particularly to FIG. 2, the system 100 includes various modules for enabling users to overcome social anxiety. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIG. 2A, in an embodiment, the behavioral traits database 202 may include a list of behavioral traits 214. Examples of behavioral traits 214 include, but not limited to, social anxiety 214a, anxiety 214b and anger 214c, among others. The traits database 202 may further include, with respect to one or more of the behavioral traits, information associated 216 with the trait 214.

With regards to social anxiety 214a, the associated information 216 may include information corresponding to the defective brain wirings (defects) 216a and 216b causing social anxiety (symptom of the defect), information about impact 216c of social anxiety 214a on a person, and a list 216d comprising one or more traits that may be confused with social anxiety 214a, among other information. Some or all of the associated information 216 may be displayed to the user of the activity module 200.

A first defective brain wiring 216a causing social anxiety 214a is the brain wiring causing an individual to focus on threatening information in social environments. A second defective brain wiring 216b causing social anxiety 214a is the brain wiring causing an individual to fear about being negatively evaluated by others.

In an embodiment, the information corresponding to the first and second defective brain wiring 216a, 216b causing the social anxiety 214a enables the activity module 200 to select games, activities or actions to overcome social anxiety 214a.

In an embodiment, displaying the information corresponding to the defective brain wiring (defect) 216a, 216b causing social anxiety 214a helps the user in understanding the defects responsible for social anxiety 214a, thereby motivating the user to follow the instructions provided by the activity module 200.

Information about impact 216c of social anxiety 214a can include one or more of fear of responding in social situations with physical symptoms of increased heart rate, sweating, headaches and/or difficulty in breathing, tendency to avoid social situations, repetitive thoughts of anticipatory criticism from others, excessive focus on the self and becoming conscious of the way they come across to others and not liking being the center of attention in any situation, among others.

The list 216d of other traits that can be confused with social anxiety 214a include anxiety, introversion, low self esteem and submissiveness, among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome social anxiety 214a.

With regards to social anxiety 214a, the brain rewiring attempted to achieve to overcome social anxiety 214a includes rewiring the defective brain wirings 216a, 216b such that ability to focus or prioritize on non threatening information in social environments is increased and ability to balance between positive and negative evaluation by other people and deciding if the experience is good or not, is increased.

In an embodiment, the activity module 200 may display the information corresponding to the causes (genetic or environmental) that resulted in the defective brain wirings (defect) 216a, 216b, which in turn resulted in social anxiety 214a, thereby enabling the user to relate to the cause, defect and symptom of the defect, which results in a wholesome experience while working to overcome social anxiety 214a.

### Collection of Games 204

The activity module 200 includes a collection of digital games 204, which are played in a virtual world. Each of the games 204 is used by the activity module 200 based on the brain rewiring, which the game 204 is capable of achieving.

Referring to FIG. 2B, in an embodiment, each game 204a-204c (may be referred to as game 204 or games 204) may include associated information 218. As an example, a game may be capable of achieving more than one type of brain rewiring. Alternatively, one single type of rewiring may be achieved through more than one game. Each game 204 includes data indicating the brain rewiring(s) 219, 225 it is capable of achieving, so that the activity module 200 can opt to present a choice of one or more games, which has the capability to achieve the brain rewiring, which the activity module 200 is attempting to achieve.

The associated information 218 may further include instructions 221 to be followed by the user to play the game 204. The associated information 218 may additionally include one or more rules 223. Examples of rules include rules for playing each game, rules to proceed to a higher level, scoring method in each level and time assigned to each level to reach the end of the level, among others.

In an embodiment, a higher level of the digital game 204 is unlocked based on predefined criteria.

In an embodiment, the higher level is unlocked upon repeatedly playing a previous level in the digital game 204 for a predefined number of times or duration of time.

In the example presented in FIG. 2B, three different games 204a-204c are included in the collection of games 204. The three games 204a, 204b and 204c can be used by the activity module 200 to correct the defective brain wirings 216a and 216b by rewiring the brain to increase the ability to focus or prioritize on non threatening information in social environments 219 and increase ability to balance between positive and negative evaluation by other people and decide if the experience is good or not 225.

Game A 204a is directed at rewiring 219 the brain to increase the ability to focus or prioritize on non threatening information in social environments. The games, 204b and 204c are directed at rewiring 225 the brain to increase the ability to balance between positive and negative evaluation by other people and decide if the experience is good or not.

Game A 204a may be designed to rewire the brain to increase the ability to focus or prioritize on non threatening information in social environments 219. Game A 204a may be developed to train individuals with social anxiety to focus on the non threatening faces among different faces in social environments (both threatening and non threatening). Game A 204a may further be helpful in training individuals to interpret the appropriate emotions that other people go through faster. The instruction 221a may include recommendation to play the game 204a for a minimum duration every day. The rules 223a may allow proceeding to a next level in the game 204a once a desired level of performance is achieved, for example, if an individual is able to select the positive faces (stimuli) in less than 100 ms for at least ten pairs in each level, only then he may be allowed to move to the next level.

The goal of the game 204a is to see how fast the individuals select the positive stimuli over the threatening stimuli. A track of the time needs to be kept which may not be shown to the user. Stimuli (happy and threatening faces of real people) may be shown in the following list of social situations.

1. Birthday party.

2. Presentation in front of a crowd.

3. A mall.

4. Restaurant.

5. Stadium.

6. College Canteen.

7. Airport.

8. Bar.

9. Conference.

10. Grocery store.

11. A crowded street

In a first level, stimuli in the form of threatening and non-threatening faces of people are shown to the user. The user has to select the positive or non threatening stimuli. The first level may further include a plurality of sub levels.

In a sub level 1, two stimuli, one happy and one threatening face of people will be shown. These stimuli (but with different faces) will repeat till 25 pairs are shown (1 happy and 1 threatening). The user has to select the happy face over the threatening face.

In sub level 2, four stimuli, happy or threatening faces of people will be shown on the screen. These stimuli (but with different faces) will repeat till 25 pairs are shown (1 happy and 3 threatening). The user has to select the happy faces over the threatening faces.

In a sub level 3, four stimuli, 2 happy and 2 threatening faces of real people are shown. These stimuli (but with different faces) will repeat till 25 pairs are shown. The user has to select the happy faces over the threatening faces.

In a sub level 4, four stimuli, 2 happy, 1 threatening and 1 neutral faces of real people are shown. These stimuli (but with different faces) will repeat till 25 pairs are shown. The user has to select the happy faces over the threatening faces.

In a sub level 5, 8 faces with different emotions and multiple positive faces will be shown. The user has to select all the happy faces.

A second level of the Game A 204a may include a plurality of sub levels. In a sub level 1, four people in different social situations will be shown (faces and body language) to the user. The user has to choose the people with a positive face and body language.

In a sub level 2, eight to ten people in different social situations will be shown (faces and body language). The user has to choose the people with a positive face and body language.

Game B 204b may be designed to enhance one's ability to balance between positive and negative evaluation of people and decide if the experience is good or not 225. The instruction 221b may include recommendation to play the game 204b for at least a predefined duration for a predefined number of days. The rules 223b may allow proceeding to a next level in the game 204b once a desired level of performance is achieved.

As an example, a fact may be presented to the user. The user has to choose a correct answer based on a choice of facts provided, which are related to the primary fact. One example is presented below:

### Example

1. You are going to receive an award

### True Facts:

You are dressed well

Good profiling speech

High personal qualification

People are laughing

According to you, will you be criticized?

Yes

No

Game C 204c game may be designed to enhance one's ability to balance between positive and negative evaluation of people and decide if the experience is good or not 225. The instruction 221c may include recommendation to play the game 204c for at least a predefined duration for a predefined number of days. The rules 223c may allow proceeding to a next level in the game 204c once a desired level of performance is achieved.

In the game C 204c, the user may be presented with situations/events and based on that the user may be presented with question for which the user may have to provide appropriate answers.

An example is presented below:
Situation/event: There can be a group of three teams from different companies who need to make a presentation of a proposal for a new tender. Each team consists of two people. One person has to prepare the material and the other needs to present it in front of the committee.
Q. So in this situation, would you choose to be the one to make the presentation?

### A:

I don't think I am good at making presentations. So I will not.

I will take this up as an opportunity. So I will make the presentation.

Situation/event: In the process of collecting material, you get information about the weak points of your competitors.
Q. So will you use this knowledge and agree to make the presentation yourself? A:

I will tell my colleague about the weak points of the competitors. So I will still not present.

I will use my background research and knowledge and make a brilliant presentation.

Situation/event: While talking to your teammate, you realize that his communication skills are not that great.
Q. So will you then be willing to use your communication skills to make the presentation?

### A:

I will train my colleague on better communication skills for the presentation. So I will still not do it.

I will use my ability to communicate and change my decision and will make a good presentation.

Situation/event: There is one day to go, and your colleague calls you up saying he is unwell and would not be able to give the presentation.
Q. So will you now take up this challenge and stand up to the situation and make a presentation?

### A:

I will stand up to the occasion and practice the presentation the whole day, so my company gets the tender.

I will not give the presentation and allow my competitors to get the tender.

### Actions Database 206

The actions database 206 includes information corresponding to a plurality of real world activities or sets of real world activities. Real world activities may include activities that are performed in a real world environment, as opposed to the digital games played in the virtual world (ex: games included in the collection of games 204).

Referring to FIG. 2C, each of the real world activities 220a-220b (may be referred by numeral 220) or sets of real world activities 220a-220b (may be referred by numeral 220) is used by the activity module 200 based on the brain rewiring 219, 225, which the real world activity 220 is capable of achieving.

Each real world activity 220 may include associated information 222. As an example, a real world activity may be capable of achieving more than one type of brain rewiring. Each real world activity 220 includes data indicating the brain rewiring(s) 219, 225 it is capable of achieving, so that the activity module 200 can opt to present a choice of one or more real world activities 220, which has the capability to achieve the brain rewiring, which the activity module 200 is attempting to achieve.

The associated information 222 may further include instructions 227 to be followed by the user to perform the real world activity 220 or a set of real world activities 220. The associated information 222 may additionally include one or more rules 229. Examples of rules include rules to proceed to a higher level, scoring method in each level and time assigned to each level to reach the end of the level, among others.

The real world activity 220a may be presented to the user after the user has at least participated in one or more games to a predefined extent that attempts to rewire 219 the first defective brain wiring 216a. The real world activity 220a may be designed to rewire the brain to increase the ability to focus or prioritize on non threatening information in social environments. Instructions 227a may include recommendation that the action has to be carried out every day and rules 229a may state that each level has to be repeated 3 times, before the next level unlocks.

In a first level, the activity module 200 may present tasks listed below and may present them sequentially. The tasks are to be shown only one at a time and “next” option should be shown to show the next task in the sequence.

Screen 1 shows the tasks:
In your daily environment, focus on those adults who are happy and count those number of people that you see today.
In your daily environment, focus on the children who are happy and count those number of children that you see today.
In your daily environment, focus on those old people who are happy and count the number of those old people that you see today.

### Screen 2:

At the end of the day, kindly write down the number of happy individuals you saw. In that list, write down the names of as many people as you know/remember. An empty box may be provided to write the names of the people the user saw, know and remember.

In a Second Level:

### Screen 1:

In your daily environment, focus on all those people who have a positive/welcoming gesture towards you or appreciate you for something you did/spoke.

### Screen 2:

At the end of the day, kindly write down the number of people who were positive towards you. In that list, write down the names of as many people as you know/remember. An empty box may be provided to write the names of the people the user saw know and remember.

In a Third Level:

### Screen 1:

Today you must enter a social environment such as a restaurant, a party, a shopping mall or any place that has a lot of new people. In that environment, you should focus on the happy people who make an eye contact with you.

### Screen 2:

At the end of the day, kindly write down the number of happy people who saw you. An empty box may be provided to write the number of the happy people the user saw.

In a Fourth Level:

### Screen 1:

Today you must enter a social environment such as a restaurant, a party, a shopping mall or any place that has a lot of new people. You should focus on those people who have a positive/welcoming gesture towards you or appreciate you for something you did/spoke.

### Screen 2:

At the end of the day, kindly write down the number of people who were positive towards you. An empty box may be provided to write the number of the people who were positive towards the user.

In a Fifth Level:

### Screen 1:

In your daily/social environment, whenever someone has a positive expression/gesture towards you, then kindly smile back at them. If you feel comfortable, you can initiate a small conversation with them. This includes people who you already know and those who you don't.

### Screen 2:

Write down the number of times you smiled back at people or initiated a conversation. An empty box may be provided to write down how many times the user smiled back at people or initiated a conversation.

The real world activity 220b may be presented to the user after the user has at least participated in one or more games to a predefined extent that attempts to rewire 225 the second defective brain wiring 216b. The real world activity 220b may be designed rewire the brain to increase the ability to balance between positive and negative evaluation by other people and decide if the experience is good or not 225. Instructions 227b may include recommendation that the action has to be repeated once in a week and rules 229b may state that each level has to be repeated 3 times, before the next level unlocks.

In a First Level:

### Screen 1:

Spend some time imagining yourself in a situation where you have to talk to your group of friends about an interesting experience you had recently. Reflect on the body language you would use, your confidence and positive spirit.

### Screen 2:

If you think you would be comfortable in that situation, then move on to the next step
If it is “Yes”, then repeat the same task till 3 times are over and then move to next level.
If it is “No”, then the following message will be displayed:
“go over the same situation again, but this time you see yourself more bold and upbeat with your friends appreciating you and your confidence”.

In a Second Level:

### Screen 1:

This time, go out and meet a group of friends in person and share your experience that you thought about in the previous level.

### Screen 2:

Evaluate your experience with your friends on a scale of 1 to 10. Your experience should be positive or negative based on how the majority of the people felt. Write down the positives and negatives that you faced.

The activity module 200 may provide a scale. Table 1 shows an example of positives and negatives.

TABLE 1

| Positives | Negatives |
|---|---|
| Example: They enjoyed | Example: A few of my |
| and we all laughed | friends got bored |
| together when I | |
| was speaking | |

### Screen 3:

Overall, did you feel comfortable carrying out the action?
If “Yes”, then repeat three times and then move to next level.
If “No”, then the following message needs to be shown:
“Re-attempt again and talk to your friends about another experience that your more comfortable with and take constructive feedback from them on how you could do better. Next time you may use the following to help you:
1). Maintain eye contact whenever required.
2) Focus on those people who are interested in your conversation
2). Appropriate pauses during your conversation.
3). Relaxed posture like how you would be with yourself”

In a Third Level:

### Screen 1:

Now that you have gained certain amount of confidence, go ahead and meet new people such as your neighbours, friends of friends or any new colleague and strike a conversation with a few of them.

### Screen 2:

Evaluate your experience after meeting these new people on a scale of 1 to 10. Evaluate your experience based on how you felt after speaking with them and how others felt about the conversation. This can be gauged from verbal feedback, body language their expressions/gestures.

### Screen 3:

Overall, did you feel comfortable carrying out that action?
If “Yes”, then repeat 3 times and then move to next level.
If “No”, then the following message needs to be shown:
“Don't give up, you are almost there. This time meet new people with the presence of a known person so you do not feel anxious or awkward. Try and initiate small conversations about common interests, upcoming events or any global issue till you begin to feel comfortable”.

In a Fourth Level:

### Screen 1:

Now you have reached a stage where you are well equipped to join people for any upcoming social activity. It could be a birthday, a wedding/award ceremony, reunion and so on. It may take time for you to feel comfortable but take it slow and the anxiety will reduce with time.

### Screen 2:

Write down how you felt when you attended the social gathering and make a note of all the positive memories that you have about the event.

In a Fifth Level:

### Screen 1:

Now it is time for you to believe in yourself and go ahead and give a presentation in front of a small/large group of people. Keep the following in mind,

Rehearse well before the presentation.

Focus on those individuals who are interested in what you are saying.

Make eye contact with everyone present

Use your body language to communicate effectively

Modulate your tone of voice whenever required

### Screen 2:

Write down how you felt when you presented and the feedback that you received from others. Feel confident about the positive feedback and if you receive any negative feedback, then work on it the next time.

In a sixth level, instructions may be provided to the user by the activity module 200 to mentor another individual who has social anxiety (and who wants to change) and guide them on the skills that the user has learnt. This person could be a friend/family member or colleague of the user.

In an embodiment, the action database 206 further includes plurality of physical actions, mind actions and dietary actions, one or more of which may be presented to a user who is trying to overcome social anxiety 214a.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities (ex: games, real world activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the real world activities and determines scores of each level of real world activity based on the log that is present in the logging module 208. The assessment module 210 may also determine status of the one or more behavioral trait 214 or the brain wiring causing the trait, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

### V. METHOD FOR OVERCOMING SOCIAL ANXIETY

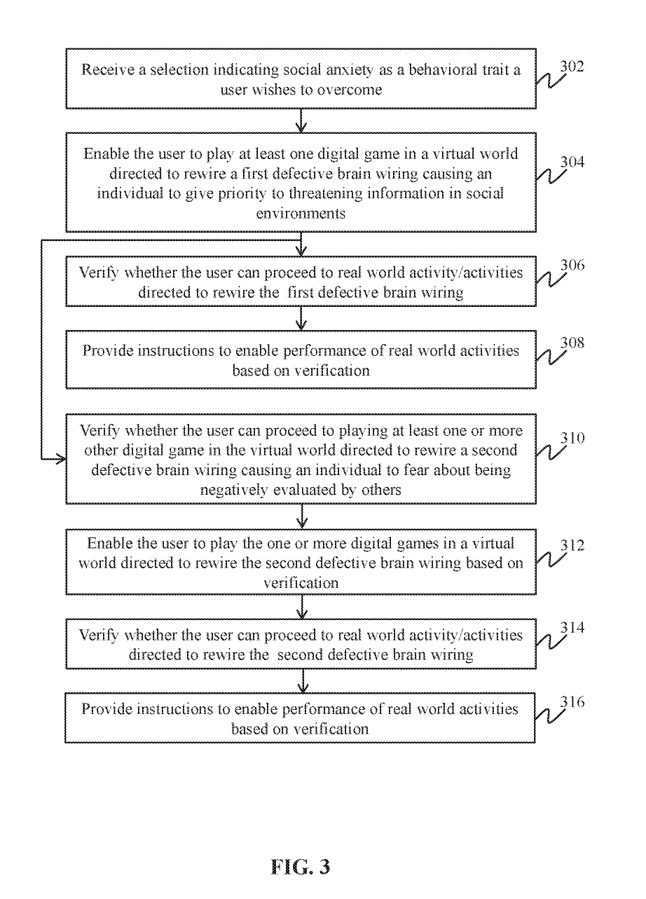

Now referring more particularly to FIG. 3, a method is provided for overcoming social anxiety 214a. A selection indicating social anxiety 214a as a behavioral trait which a user wishes to overcome is received at step 302. At step 304, a user is enabled to participate/play in at least one digital game 204a, which is played in a virtual world. The digital games 204a, is instrumental in rewiring 219 a first defective brain wiring 216a, whose symptom is exhibition of social anxiety 214a. At step 306, verification is made to determine whether the user can proceed to perform real world activities 220a. In case it is determined that user can proceed, then at step 308, instructions are provided to the user to enable the user to perform appropriate real world activity/activities 220a. Preferably, the user is allowed to perform or instructed to begin performing appropriate real world activities 220a upon participating in the digital game 204a at least to a predefined extent, which is determined based on the desired rewiring. The real world activity 220a is instrumental in rewiring 219 the first defective brain wiring 216a, whose symptom is exhibition of social anxiety 214a.

At step 310, verification is made to determine whether the user can proceed to playing at least one other digital game 204b-204c in the virtual world directed to rewire a second defective brain wiring 216b. In case it is determined that user can proceed, then at step 312 the user is enabled to participate/play in at least one digital game 204b-204c, which is played in a virtual world. The digital games 204b-204c are instrumental in rewiring 225 the second defective brain wiring 216b, whose symptom is exhibition of social anxiety 214a. Preferably, the user is allowed to proceed to playing at least one other digital game 204b-204c upon participating in the game(s) instrumental in rewiring 219 the first defective wiring 216a at least to a predefined extent, which is determined based on the desired rewiring.

At step 314, verification is made to determine whether the user can proceed to perform real world activities 220b. In case it is determined that user can proceed, then at step 316, instructions are provided to the user to enable the user to perform appropriate real world activity/activities 220b. Preferably, the user is allowed to perform or instructed to begin performing appropriate real world activities 220b upon participating in the digital game(s) 204b-204c at least to a predefined extent, which is determined based on the desired rewiring. The real world activity 220b are instrumental in rewiring 225 the second defective brain wiring 216b, whose symptom is exhibition of social anxiety 214a.

Referring to the step (302) of receiving a selection indicating social anxiety 214a, the user may be provided an option to select a behavioral trait that he would like to overcome. The activity module 200 may provide or recommend an option to select at least one weak behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of weak behavioral trait 214 the user may have. Upon selection of social anxiety 214a, the activity module 200 may display a list 216d of other behavioral traits that can be confused with social anxiety 214a, so that the user can select a more appropriate behavioral trait 214, which he desires to work on. The activity module 200 may further display the information corresponding to the brain wirings (defect) 216a, 216b causing the trait behavioral 214. The first defective brain wiring 216a causes the individual to give priority to threatening information in social environments. The second defective brain wiring 216b causes fear of negative evaluation by others in an individual.

The activity module 200 may additionally display information about impact 216c of social anxiety 214a to the user. In addition, the activity module 200 may display information corresponding to the brain rewiring 219, 225 that the activity module 200 is attempting to achieve to overcome social anxiety 214a. Rewiring 219 of the first defective brain wiring 216a results in increased ability to focus or prioritize on non threatening information in social environments. Rewiring 225 of the second defective brain wiring 216b results in increased ability to balance between positive and negative evaluation by other people and decide if the experience is good or not.

Furthermore, the activity module 200 may display the information corresponding to the causes (genetic or environmental) that resulted in the defective brain wirings (defect) 216a, 216b.

Referring to the step (304) of enabling the user to play at least one digital game in the virtual world directed to rewire the first defective brain wiring 216a, the activity module 200 may select one or more digital games based on the capability of the digital games to achieve the desired brain rewiring 219.

The activity module 200 may provide a choice (one or more games) of games, from which the user may select. The activity module 200 may even indicate the effectiveness of each of the games in achieving the desired brain rewiring 219 or an aspect of rewiring.

In an embodiment, the activity module 200 is configured to recommend a plurality of games 204, wherein the recommendation indicates each of the games' 204 effectiveness to achieve the desired brain rewiring 219 or an aspect of rewiring.

The activity module 200 allows the user to play the selected game. The logging module 208 may log the performance of the user. The assessment module 210 may determine the performance scores using the log in the logging module 208. Further, based on the respective rules 223, the user is either allowed or denied access to other levels of the game 204.

Referring to step 306, the activity module 200 verifies whether the user can proceed to perform real world activities 220. Preferably, the activity module 200 recommends real world activities 220 after the user has performed to a desired extent in the digital game(s) 204. Desired extent of performance can be, as an example, levels completed, score reached and duration over which the game 204 was played.

In an embodiment, the activity module 200 recommends participating in real world activity 220a or a part thereof, after the user has performed to a desired extent in the digital game 204a. Likewise, the activity module 200 may recommend participating in the real world activity 220b or a part thereof, after the user has performed to a desired extent in the digital game 204b and/or 204c. Desired extent of performance can be, as an example, levels completed, score reached and duration over which the game(s) were played.

In an embodiment, the activity module 200 recommends participating in a level or part of real world activity (ex: level of real world activity 220a) after the user has performed to a desired extent in a level of the digital game (ex: level of digital game 204a), wherein the level of the digital game prepares the user to participate in the level or part of the real world activity.

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

The logging module 208 may log the performance of the user. The assessment module 210 may determine the performance scores using the log in the logging module 208. Further, based on the rules 229, the user is either allowed or denied access to other levels of the real world activities or sets of real world activities.

Referring to step 310, the activity module 200 verifies whether the user can proceed to playing at least one or more other digital games in the virtual world directed to rewire the second defective brain wiring 216b causing an individual to fear about being negatively evaluated by others. Rewiring the second defective brain wiring 216b results in ability to balance between positive and negative evaluation by other people and decide if the experience is good or not.

In an embodiment, the activity module 200 recommends participating in digital games directed to rewire the second defective brain wiring 216b after the user has performed to a desired extent in the digital game(s) directed to rewire the first defective brain wiring 216a.

In an embodiment, the activity module 200 recommends participating in digital games directed to rewire the second defective brain wiring 216b after the user has performed to a desired extent in the digital game(s) and real world activity/activities directed to rewire the first defective brain wiring 216a.

The activity module 200, based on the verification, enables the user to play/participate in one or more other digital games 204b and 204c in the virtual world directed to rewire the second defective brain wiring.

In an embodiment, the activity module 200 recommends participating in real world activity 220b or part thereof after the user has performed to a desired extent in the digital game 204b. Likewise, the activity module 200 recommends participating in real world activity 220b or part thereof after the user has performed to a desired extent in the digital game 204c.

In another embodiment, the activity module 200 recommends participating in digital game 204b after the user has performed to a desired extent in a level of the digital game 204a. Similarly, the activity module 200 recommends participating in digital game 204c after the user has performed to a desired extent in a level of the digital game 204b.

Additionally, the activity module 200 may provide instruction to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The real world, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting social anxiety, the activity module 200 provides a scale operable by the user to select a position on the scale. The position may be indicative of the user's perception of his social anxiety. Improvement in social anxiety resulting from the rewiring of the brain achieved by the performance of the activities (virtual games or real world activities) enabled by the activity module 200 is reflected on the scale. Degradation of the improvement in social anxiety resulting from the degradation of the rewiring of the brain due to premature halt in performance of the activities (virtual games or real world activities) enabled by the activity module 200 is also reflected on the scale.

The games and the real world activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome social anxiety, the system comprising an activity module configured to:
enable the user to engage in at least a first activity in a virtual environment, wherein the first activity is directed to rewire a first defective wiring of the brain, wherein the first defective wiring results in prioritizing threatening information in social environments;
enable the user to engage in at least a second activity in the virtual environment, wherein the second activity is directed to rewire a second defective wiring of the brain, wherein the second defective wiring results in fear of negative evaluation by others, wherein symptom of the first and the second defective wirings is social anxiety;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain.

2. The system of claim 1, wherein the activities in the virtual environment are digital games.

3. The system of claim 1, wherein the activity module is further configured to provide the automated instructions to engage in the activity directed to rewire the first defective wiring to be performed in the real world environment, after the user has at least participated in the first activity.

4. The system of claim 1, wherein the activity module is further configured to provide the automated instructions to engage in the activity directed to rewire the second defective wiring to be performed in the real world environment, after the user has at least participated in the second activity.

5. The system of claim 1, wherein the activity module is further configured to enable the user to engage in the second activity, after the user has at least participated in the first activity.

6. A method for enabling a user to overcome social anxiety, the method comprising:
enabling the user to engage in at least a first activity in a virtual environment, wherein the first activity is directed to rewire a first defective wiring of the brain, wherein the first defective wiring results in prioritizing threatening information in social environments;
enabling the user to engage in at least a second activity in the virtual environment, wherein the second activity is directed to rewire a second defective wiring of the brain, wherein the second defective wiring results in fear of negative evaluation by others, wherein symptom of the first and the second defective wirings is social anxiety;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain.

7. The method of claim 6, wherein the activities in the virtual environment are digital games.

8. The method of claim 6, wherein the automated instructions to engage in the activity directed to rewire the first defective wiring, to be performed in the real world environment, is provided after the user has at least participated in the first activity.

9. The method of claim 6, wherein the automated instructions to engage in the activity directed to rewire the second defective wirings, to be performed in the real world environment, is provided after the user has at least participated in the second activity.

10. The method of claim 6, wherein the user is enabled to engage in the second activity, after the user has at least participated in the first activity.

11. A system for enabling a user to overcome social anxiety, the system comprising an activity module configured to:
enable the user to engage in at least a first activity in a virtual environment, wherein the first activity is directed to rewire a first defective wiring of the brain, wherein the first defective wiring results in prioritizing threatening information in social environments; and
enable the user to engage in at least a second activity in the virtual environment, wherein the second activity is directed to rewire a second defective wiring of the brain, wherein the second defective wiring results in fear of negative evaluation by others, wherein symptom of the first and the second defective wirings is social anxiety, wherein engagement in the second activity is enabled after the user has at least participated in the first activity.

12. The system of claim 11, wherein,
the first activity is directed to rewire the first defective wiring to increase the ability to prioritize on non threatening information in social environments; and
the second activity is directed to rewire the second defective wiring to increase the ability to balance between positive and negative evaluation by other people and decide if the experience is good or not.
